(19) United States
(12) Patent Application Publication
(10) Pub. No.: US 2007/0233349 A1
(43) Pub. Date: Oct. 4, 2007

(54) Method and apparatus for dynamic control of engine settings in a delivery vehicle

(76) Inventor: Michael Lee Segal, Carlsbad, CA (US)

Correspondence Address: QUALCOMM INCORPORATED, 5775 MOREHOUSE DR., SAN DIEGO, CA, 92121, US

(21) Appl. No.: 11/394,060

(22) Filed: Mar. 29, 2006

(51) Int. Cl. G06F 17/00

(52) U.S. Cl. 701/57; 701/1; 701/2

(57) ABSTRACT

Method and apparatus for dynamic control of engine settings in a delivery vehicle. A method is provided for dynamically setting engine parameters in a vehicle. The method includes detecting one or more operational parameters, obtaining one or more engine parameters based on the one or more operational parameters, and setting the one or more engine parameters.

### BACKGROUND

I. Field

The present invention relates generally to transportation and delivery systems, and more particularly, to methods and apparatus for dynamic control of engine settings in a delivery vehicle.

II. Description of the Related Art

Advances in technology have provided for increased automation in many industries. For example, in the shipping industry, technology has allowed for the shipment and delivery of cargo virtually around the clock. Delivery vehicles now carry and deliver cargo to all parts of the country. For example, in the trucking industry, cargo-carrying tractor-trailers may be driven hundreds or thousands of miles to reach a delivery site. In some cases, a delivery vehicle may make several intermediate stops before reaching its final destination. Thus, it is important for delivery vehicles to operate in a manner that optimizes fuel efficiency while providing satisfactory vehicle performance.

Typically, truck engines have parameters that can be electronically set to control engine performance. Among those parameters are a “top speed” parameter and a “peak engine torque” parameter. The engine parameters of delivery vehicles in a fleet are generally fixed to pre-established values by fleet operational personnel at selected repair and maintenance centers. Values are typically selected so that the delivery vehicles may operate over a variety of road and/or environmental conditions.

Unfortunately, because a pre-established value is used for each parameter, compromises are made. For example, the pre-established engine torque parameter is set to allow vehicles to have enough torque to climb mountain highways. However, that same torque value is used when vehicles are crossing the Great Plains. Thus, the engine performance and fuel efficiency of the delivery vehicles are not optimized for the variety of road conditions that may be encountered along a particular delivery route.

Therefore, what is needed is a way to dynamically set the engine performance of delivery vehicles based on the current road conditions or other operational parameters, so that fuel efficiency and engine performance can be optimized.

### SUMMARY

In one or more embodiments, an engine control system, comprising methods and apparatus, is provided that operates to dynamically control engine settings in a delivery vehicle. For example, the system operates to dynamically control engine settings based on the current road conditions, geography, vehicle load, or other operational parameters associated with a particular vehicle. In one embodiment, engine control messages are transmitted to a delivery vehicle from a remote station and operate to dynamically adjust the vehicle's engine parameters. As a result, it is possible to dynamically control the engine settings for any particular vehicle and thereby control performance, fuel utilization or other characteristic of the vehicle's engine.

In one embodiment, a method is provided for dynamically setting engine parameters in a vehicle. The method comprises detecting one or more operational parameters, obtaining one or more engine parameters based on the one or more operational parameters, and setting the one or more engine parameters.

In another embodiment, an apparatus is provided for dynamically setting engine parameters in a vehicle. The apparatus comprises logic configured to detect one or more operational parameters, and logic configured to obtain one or more engine parameters based on the one or more operational parameters. The apparatus also comprises logic configured to set the one or more engine parameters.

In another embodiment, an apparatus is provided for dynamically setting engine parameters in a vehicle. The apparatus comprises means for detecting one or more operational parameters, and means for obtaining one or more engine parameters based on the one or more operational parameters. The apparatus also comprises means for setting the one or more engine parameters.

In another embodiment, a computer-readable media is provided that comprises program instructions, which when executed by at least one processor, operate to dynamically set engine parameters in a vehicle. The computer-readable media comprises instructions for detecting one or more operational parameters, and instructions for obtaining one or more engine parameters based on the one or more operational parameters. The computer-readable media also comprises instructions for setting the one or more engine parameters.

In another embodiment, at least one processor is provided that is configured to perform a method for dynamically setting engine parameters in a vehicle. The method comprises detecting one or more operational parameters, and obtaining one or more engine parameters based on the one or more operational parameters. The method also comprises setting the one or more engine parameters.

Other aspects of the embodiments will become apparent after review of the hereinafter set forth Brief Description of the Drawings, Detailed Description, and the Claims.

### BRIEF DESCRIPTION OF THE DRAWINGS

The foregoing aspects of the embodiments described herein will become more readily apparent by reference to the following detailed description when taken in conjunction with the accompanying drawings wherein:

FIG. 1 shows one embodiment of an engine control system for use with a delivery vehicle;

FIG. 2 shows a detailed diagram of delivery vehicle comprising one embodiment of an engine control system;

FIG. 3 shows a detailed diagram of one embodiment of engine control logic; and

FIG. 4 shows one embodiment of a method for providing one embodiment of an engine control system.

### DETAILED DESCRIPTION

The following detailed description describes an engine control system comprising methods and apparatus for real-time dynamic control of engine performance in a delivery vehicle. It should be understood that the embodiments described herein could be used in conjunction with virtually any type of delivery vehicle including, but not limited to, trucks, buses, trains, aircraft, and automobiles.

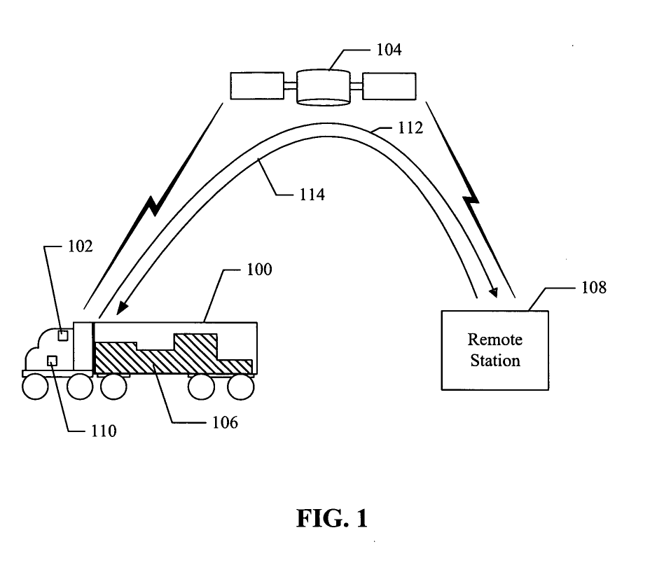

FIG. 1 shows one embodiment of an engine control system for use with a delivery vehicle 100. The vehicle 100 in this example comprises a tractor-trailer, commonly used in the long-haul trucking industry to transport goods from shippers to consignees. The vehicle 100 further comprises a mobile communication terminal (MCT) 102 for communicating with one or more remote stations using a satellite-based wireless communication system and satellite 104. The communication system provides two-way communication channels between delivery vehicles and third parties, such as a fleet management center or dispatch center, customers, family members, governmental authorities, consignees, shippers, or other remote stations. Generally, the MCT 102 resides onboard a tractor portion of the vehicle 100 so as to be easily accessible by the vehicle operator. The trailer portion of the vehicle 100 includes cargo 106 to be delivery to one or more delivery sites.

In one embodiment, a remote station 108 comprises a central processing center, otherwise known as a central station, hub, or network management center (NMC), and serves as a central communication point between MCT-equipped vehicles and their respective dispatch centers, other designated offices, shippers, consignees, governmental authorities, family members, and so on.

The MCT 102 located on vehicle 100 transmits and receives wireless communications using the satellite-based wireless communication system to communicate with the remote station 108. Other wireless communication systems could be used in addition or in the alternative, such as an analog or a digital cellular telephone system, an RF communication system, or a wireless data communication network, such as a cellular digital packet data (CDPD) network. Thus, it is possible for information to be exchanged between the vehicle 100 and the remote station 108 using the satellite-based wireless communication system or suitable alternative communication system.

The vehicle 100 includes an engine control system 110 that is located in the tractor portion of the vehicle. In one embodiment, the engine control system 110 operates to set engine operating parameters based on commands received from the remote station 108 through the satellite 104. In another embodiment, the engine control system 110 operates to set engine operating parameters based on information detected at the vehicle 100. For example, the information detected at the vehicle 100 may comprise engine parameters, geography, road conditions, vehicle position, load parameters, and/or any other type of operational parameters.

In one embodiment, the engine control system 110 detects information comprising operational parameters at the vehicle 100 and transmits this information to the remote station as shown by path 112. The remote station processes the received information and generates one or more control messages that are transmitted back to the vehicle 100 as shown by path 114. The engine control system 110 processes the received control messages to determine how to adjust one or more engine parameters. Thus, the engine control system 110 operates to dynamically adjust engine parameters in real-time based on a variety of operational parameters so that engine performance and/or fuel utilization may be optimized.

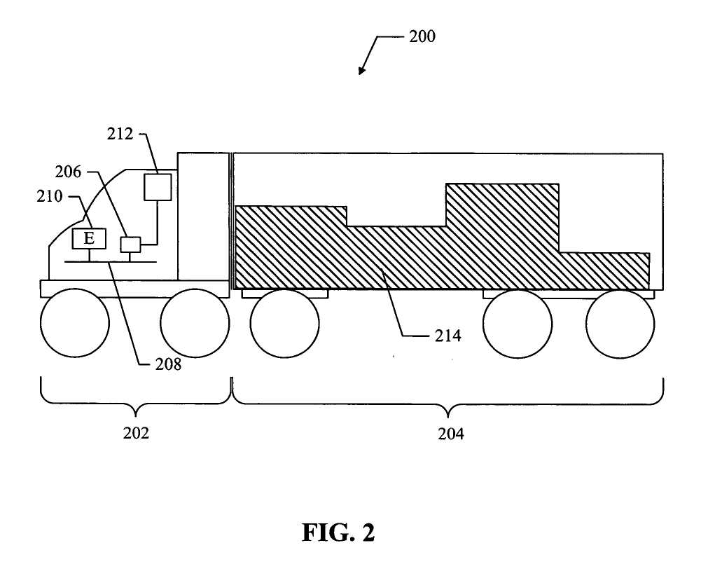

FIG. 2 shows a detailed diagram of a delivery vehicle 200 that includes one embodiment of an engine control system. The delivery vehicle 200 comprises a tractor portion 202 and a cargo-carrying trailer portion 204 that can be attached or detached as desired to facilitate efficient routing of the cargo 214. The tractor portion 202 comprises the engine control logic 206 coupled to an internal vehicle data bus 208. The vehicle engine 210 is also coupled to the data bus 208, and a MCT 212 is coupled to the engine control logic 206.

In one embodiment, the vehicle data bus 208 comprises any suitable type of vehicle communication bus that allows vehicle parameters and/or other information to be passed between various vehicle systems. For example, the data bus 208 may convey engine parameters, fuel parameters, display information, load information, ignition system information, and/or vehicle status information. In one embodiment, the engine control logic 206 may obtain parameters through the data bus 208 that describe the operation of the engine 210. In another embodiment, the engine control logic 206 may set one or more engine settings or parameters through the data bus 208.

The MCT 212 operates to communicate with one or more remote stations through a wireless communication channel. For example, the MCT 212 communicates through a satellite communication system or any other suitable communication system. In one embodiment, the engine control logic 206 determines one or more vehicle or operational parameters from the data bus 208 and passes these parameters to the MCT 212. For example, the engine control logic 206 determines the engine's current peak torque parameter and the current engine RPM value from the data bus 208. The MCT 212 transmits these parameters to a remote station through a wireless communication channel. The remote station responds by transmitting one or more engine control messages back to the MCT 212 over the wireless communication channel. For example, the engine control messages may operate to increase the engine's peak torque value. The MCT 212 passes these messages to the engine control logic 206. The engine control logic 206 processes the received messages and sets or adjusts one or more parameters associates with the engine 210 using the data bus 208. For example, the engine control logic 206 operates to adjust the engine's peak torque value based on the received message. Thus, embodiments of the system operate to dynamically set engine parameters based on one or more conditions or operating parameters.

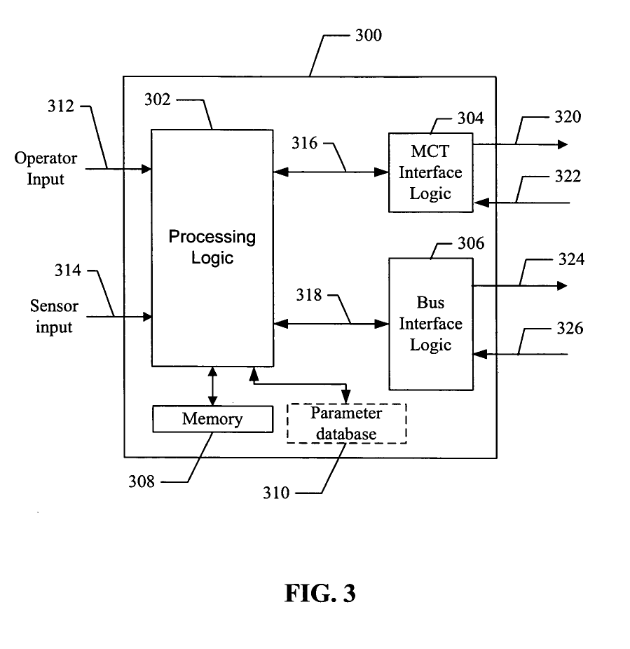

FIG. 3 shows a detailed diagram of one embodiment of engine control logic 300 for use in one embodiment of an engine control system. For example, the engine control logic 300 is suitable for use as the engine control logic 206 shown in FIG. 2. The engine control logic 300 comprises processing logic 302, MCT interface logic 304, bus interface logic 306, a memory 308, and optional parameters database 310.

The processing logic 302 comprises a processor, CPU, gate array, logic, discrete circuitry, software, and/or any combination of hardware and software. Thus, the processing logic 302 generally comprises logic to execute machine readable instructions and to control other elements of the engine control logic 300 to perform the functions described herein.

The processing logic 302 comprises logic to receive operator input 312 and logic to receive vehicle sensor input 314. For example, the operator input 312 is received from an operator input device comprising a keyboard, keypad, remote input, or input from any type of vehicle buttons or switches. The sensor input 314 comprises input from any type of vehicle sensors comprising, door sensors, ignition sensors, position sensors, fuel sensors or any other type of vehicle sensor.

The processing logic 302 communicates with the bus interface logic 306 through the communication link 318. The bus interface logic 306 comprises a processor, CPU, gate array, logic, discrete circuitry, software, and/or any combination of hardware and software. The bus interface logic 306 operates to provide communications between the engine control logic 300 and a vehicle data bus. For example, the vehicle data bus may be the data bus 208 shown in FIG. 2. Because of advances in engine technology, functions such as the electronic ignition, and other engine parameters are all settable. For example, the vehicle's engine has standard and proprietary parameters that can be programmed through the vehicle's data bus. These settable parameters control the performance of the vehicle's engine. For example, the engine's peak torque, peak speed, or other engine operating characteristics may be controlled by setting the appropriate engine parameters. For instance, if it is very cold, an idle time parameter may be set to provide additional idle time. Additionally, in one or more embodiments, drivers may be rewarded for efficient fuel use by being less restrictive on the engine parameter settings. For example, drivers that have operated the vehicle to obtain good fuel efficiency may be given more flexibility to make operating choices pertaining to the vehicle's performance.

In one embodiment, engine parameters from the engine control logic 300 may be posted on the vehicle data bus through the output bus channel 324. The posted engine parameters are processed by suitable bus logic to program the vehicle's engine to operate using the posted parameters. Additionally, information available on the vehicle data bus may be received by the engine control logic 300 through the input bus channel 326. For example, existing engine parameters or other vehicle parameters or status indicators may be obtained from the data bus through the input bus channel 326. The input 326 and output 324 bus channels may comprise any suitable logic or communication technology to allow the engine control logic 300 to communicate with the vehicle data bus.

The processing logic 302 communicates with the MCT interface logic 304 through the communication link 316. The MCT interface logic 304 comprises a processor, CPU, gate array, logic, discrete circuitry, software, and/or any combination of hardware and software. The MCT interface logic 306 operates to provide communications between the engine control logic 300 and an onboard MCT. The MCT operates to communicate with a remote station through a wireless communication channel. For example, the wireless communication channel may comprise a satellite communication channel, as shown in FIG. 1, or a terrestrial based communication channel. Information from the engine control logic 300 may be transmitted to the remote station through an output MCT channel 320. Information passed through the output MCT channel 320 is input to the onboard MCT for transmission to the remote station. Information available at the remote station may be transmitted to the engine control logic 300 and received at an input MCT channel 322. For example, the onboard MCT receives transmissions from the remote station and passes the received information to the engine control logic 300 through the input MCT channel 322. The input 322 and output 320 MCT channels may comprise any suitable logic or communication technology to allow the engine control logic 300 to communicate with the onboard MCT.

The memory 308 is coupled to the processing logic 302 to allow information at the processing logic 302 to be stored for subsequent processing. For example, vehicle sensor information received through the sensor input 314, or operational information received through the operator input 312 may be stored in the memory 308. The memory 308 may also store information obtained from the vehicle data bus through the bus interface logic 306.

During operation of the engine control logic 300, the processing logic 302 obtains one or more operational parameters associated with the vehicle. For example, the operational parameters include current road conditions, engine performance, fuel utilization, vehicle position, weather, delivery route considerations, load conditions, and/or any other type of parameters relating to the vehicle, driver, environment, or operation of the vehicle. In one embodiment, the processing logic 302 stores the operational parameters in the memory 308 for later processing and to create an historical record of information.

In one embodiment, the processing logic 302 transmits the obtained operational parameters to a remote station through the MCT interface logic 304. For example, the processing logic 302 passes the operational parameters to the MCT interface logic 304, which in turn transmits the parameters through the output MCT channel 320 to the onboard MCT. The onboard MCT then transmits the operational parameters to the remote station using a wireless communication channel. Systems at the remote station process the operational parameters to determine engine parameters that are to be applied to the vehicle's engine to achieve selected engine performance or fuel utilization based on the existing operational parameters.

In one embodiment, the systems at the remote station transmit the engine parameters to the MCT onboard the vehicle using the wireless communication channel. The MCT then passes the engine parameters to the engine control logic 300 through the MCT interface logic 304. The MCT interface logic 304 then passes the received engine parameters to the processing logic 304 through the link 316.

The processing logic 302 receives the engine parameters and performs one or more functions. For example, the processing logic 302 stores the engine parameters in the memory 308. The processing logic 302 may also process the engine parameters into engine messages that are passes through the link 318 to the bus interface logic 306. The bus interface logic 306 operates to post the engine messages on the vehicle bus through the output bus channel 324. Vehicle logic associated with the vehicle engine processes the engine messages on the vehicle data bus to set the engine parameters. As the result, the engine parameters operate to set the operation of the vehicle's engine to obtain selected performance or fuel efficiency.

In one embodiment, a large number of parameters and/or control instructions are required to program the vehicle's engine with the new engine parameters. Because of this, it may be inefficient for the remote station to transmit over-the-air all the required information needed to program the engine. Thus, the remote station may utilize “macro messages” to transmit the information in a more efficient transmission. The macro messages are shortened pre-defined messages which can be decoded by the processing logic 302. Thus, by transmitting a macro message to “increase torque”, the processing logic 302 may decode this message to determine all the parameters and control instructions that are need to perform this function. The processing logic 302 then posts this decoded information on the vehicle data bus to perform the programming process. In one embodiment, another device or third party processor is used to obtain the parameters and control instructions needed to reprogram selected engine parameters.

In one embodiment, the engine parameters are stored in the optional parameters database 310. The database 310 comprises engine parameters associated with various operational parameters. For example, information in the database 310 may be updated by transmissions from a remote station that are received through the MCT interface logic 304 and stored in the database 310 by the processing logic 302. Once the processing logic 302 determines one or more operational parameters, the processing logic 302 accesses the database 310 to obtain associated engine parameters. These engine parameters are used to generate engine control messages that are transmitted on the vehicle's data bus through the bus interface logic 306. As a result, the vehicle's engine parameters can be set to control engine performance or fuel utilization. Thus, dynamic control of the vehicle's engine performance based on selected operational parameters may be achieved using information stored locally at the engine control logic 300.

It should be noted that embodiments of the engine control system operate in real-time to dynamically reprogram or adjust a vehicle's engine performance. For example, the vehicle's engine performance may be adjusted based on geography, load, or other conditions or operational parameters. In one embodiment, the system also operates to adjust the vehicle's engine performance based on operator performance. For example, to conserve fuel and associated costs, the vehicle's speed, idle, and engine RPMs may be monitored to see if the vehicle operator is complying with selected operating criteria. If it is determined that the operator is complying with the operating criteria, the engine control system may be used to dynamically adjust the performance of the vehicle's engine to reward the operator for good performance. For example, if the operator has driven at a target speed for a selected time period, and thereby saved fuel, the vehicle's engine is adjusted to provide additional performance as a reward.

In one embodiment, the engine control system comprises program instructions stored on a computer-readable media, which when executed by a processor, such as the processing logic 302, provides the functions as described herein. For example, instructions may be loaded into the processing logic 302 from a computer-readable media, such as a floppy disk, CDROM, memory card, FLASH memory device, RAM, ROM, or any other type of memory device or computer-readable media that interfaces to the processing logic 302. In another embodiment, the instructions may be downloaded into the processing logic 302 from an external resource. The instructions, when executed by the processing logic 302, provide one or more embodiments of an engine control system as described herein.

It should be understood that the functional elements shown in FIG. 3 represent just one implementation and that other implementations of the engine control logic 300 could be achieved in one of any number of ways using greater or fewer functional elements. For example, some or all of the functional elements of the engine control logic 300 could be implemented in a computer program executed by one or more processors. It should also be noted that although described with reference to controlling the vehicle's engine performance, embodiments of the system may be used to control other vehicle systems in a similar fashion. For example, with only minor modifications, the system may operate to control the vehicle's cooling system, suspension system or other vehicle system.

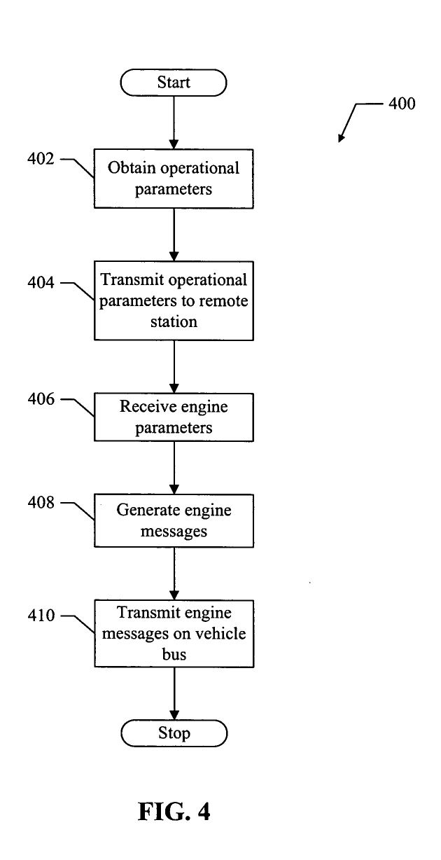

FIG. 4 shows one embodiment of a method 400 for providing one embodiment of an engine control system. For example, the method 400 is suitable for use with one or more embodiments of the engine control logic 300 described herein. For clarity, the method 400 is described herein with reference to the engine control logic 300 shown in FIG. 3. It will be assumed that the engine control logic 300 is installed in a delivery vehicle that is carrying cargo to be delivered to one or more delivery sites. It will be further assumed that the delivery vehicle includes an MCT and associated communication logic to communicate with a remote station using a wireless communication channel.

At block 402, vehicle operational parameters are obtained. For example, the processing logic 302 obtains the operational parameters that may comprise information from the vehicle operator, information from vehicle sensors, information obtained from a vehicle data bus, or any other type of operational information. The operational parameters may be stored in the memory 308.

At block 404, one or more of the operational parameters are transmitted to a remote station. For example, the processing logic 302 operates to pass the operational parameters to the MCT interface logic 304, which transmits the parameters to a remote station through the onboard MCT. The parameters may be formatted in any suitable message format, and in one embodiment, are transmitted to the remote station using a satellite communication channel. The remote station operates to process the operational parameters to determine one or more engine parameters. Systems at the remote stations may use any processing technique to generate the engine parameters, and the remote station may consider real-time data or any other stored information with which to generate the engine parameters. The engine parameters are generated such that when the parameters are applied to the vehicle's engine, selected engine performance and/or fuel utilization may be achieved. The remote station then operates to transmit the engine parameters back to the vehicle.

At block 406, engine parameters are received from the remote station. In one embodiment the engine parameters are transmitted over a satellite communication channel and received by the onboard MCT. The MCT passes the received engine parameters to the MCT interface logic 304, which in turn passes the parameters to the processing logic 302.

At block 408, engine messages are generated for transmission on the vehicle's data bus. For example, the processing logic 302 processes the received engine parameters to generate the engine messages. In one embodiment, the processing logic 302 may obtain information from the memory or from other vehicle systems to process with the engine parameters to generate the engine messages. For example, the engine parameters may be received in the form of macro messages and the processing logic 302 operates to decode the macro messages into the engine control messages. Other vehicle devices or systems may also be used to generate command or control information necessary to reprogram the engine parameters. In one embodiment, the processing logic 302 formats the engine messages to be compatible with the vehicle's internal data bus.

At block 410, the engine messages are posted on the vehicle data bus. In one embodiment, the processing logic 302 passes the engine messages to the bus interface logic 306 using the link 318. The bus interface logic 306 then posts the engine messages on the vehicle data bus using the output bus channel 304. Once on the vehicle's data bus, the engine messages are processed by logic on the vehicle that is configured to set the engine's operating settings based on the engine parameters in the engine messages. As a result, the engine's operation will be set according to the engine parameters contained in the engine messages to achieve selected engine performance and/or fuel utilization.

Thus, the method 400 operates to provide an engine control system that provides real-time dynamic control of the operating parameters of an engine in a delivery vehicle. It should be noted that the method 400 is just one implementation and that changes, combinations, deletions, additions or other modifications to the described functions can be made within the scope of the various embodiments. For example, if the engine control logic 300 comprises the optional database 310, blocks 404 and 406 may be replaced with a function of accessing the database 310 to obtain the engine parameters. As a result, transmissions to the remote station may be reduced or eliminated.

Therefore, an engine control system for real-time dynamic control of engine parameters in a delivery vehicle is described herein. Accordingly, while one or more embodiments have been illustrated and described, it will be appreciated that various changes can be made to the embodiments without departing from their spirit or essential characteristics. Therefore, the disclosure and descriptions herein are intended to be illustrative, but not limiting, of the scope of the invention, which is set forth in the following claims.

I claim:

1. A method for dynamically setting engine parameters in a vehicle, the method comprising:
detecting one or more operational parameters;
obtaining one or more engine parameters based on the one or more operational parameters;
setting the one or more engine parameters.

2. The method of claim 1, wherein said detecting comprises detecting the one or more operational parameters, wherein the operational parameters comprise one or more of a vehicle position indicator, an engine indicator, a vehicle sensor indicator, and an operator indicator.

3. The method of claim 1, wherein said obtaining comprises:
transmitting the one or more operational parameters; and
receiving a transmission comprising the one or more engine parameters.

4. The method of claim 3, wherein said receiving comprises receiving a transmission comprising the one or more engine parameters in one or more macro messages.

5. The method of claim 1, wherein said obtaining comprises accessing a database to obtain the one or more engine parameters.

6. The method of claim 1, wherein said setting comprising transmitting the one or more engine parameters on a vehicle data bus.

7. Apparatus for dynamically setting engine parameters in a vehicle, the apparatus comprising:
logic configured to detect one or more operational parameters;
logic configured to obtain one or more engine parameters based on the one or more operational parameters;
logic configured to set the one or more engine parameters.

8. The apparatus of claim 7, wherein said one or more operational parameters comprise one or more of a vehicle position indicator, an engine indicator, a vehicle sensor indicator, and an operator indicator.

9. The apparatus of claim 7, wherein said logic configured to obtain comprises:
logic configured to transmit the one or more operational parameters; and
logic configured to receive a transmission comprising the one or more engine parameters.

10. The apparatus of claim 9, wherein said one or more engine parameters are formatted in one or more macro messages.

11. The apparatus of claim 7, wherein said logic configured to obtain comprises logic configured to access a database to obtain the one or more engine parameters.

12. The apparatus of claim 7, wherein said logic configured to set comprises logic configured to transmit the one or more engine parameters on a vehicle data bus.

13. Apparatus for dynamically setting engine parameters in a vehicle, the apparatus comprising:
means for detecting one or more operational parameters;
means for obtaining one or more engine parameters based on the one or more operational parameters;
means for setting the one or more engine parameters.

14. The apparatus of claim 13, wherein said means for detecting comprises means for detecting the one or more operational parameters, wherein the operational parameters comprise one or more of a vehicle position indicator, an engine indicator, a vehicle sensor indicator, and an operator indicator.

15. The apparatus of claim 13, wherein said means for obtaining comprises:
means for transmitting the one or more operational parameters; and
means for receiving a transmission comprising the one or more engine parameters.

16. The apparatus of claim 15, wherein said means for receiving comprises means for receiving a transmission comprising the one or more engine parameters in one or more macro messages.

17. The apparatus of claim 13, wherein said means for obtaining comprises means for accessing a database to obtain the one or more engine parameters.

18. The apparatus of claim 13, wherein said means for setting comprises means for transmitting the one or more engine parameters on a vehicle data bus.

19. A computer-readable media comprises program instructions, which when executed by at least one processor, operate to dynamically set engine parameters in a vehicle, the computer-readable media comprising:
instructions for detecting one or more operational parameters;
instructions for obtaining one or more engine parameters based on the one or more operational parameters;
instructions for setting the one or more engine parameters.

20. The computer-readable media of claim 19, wherein said instructions for detecting comprise instructions for detecting the one or more operational parameters, wherein the operational parameters comprise one or more of a vehicle position indicator, an engine indicator, a vehicle sensor indicator, and an operator indicator.

21. The computer-readable media of claim 19, wherein said instructions for obtaining comprise:
instructions for transmitting the one or more operational parameters; and
instructions for receiving a transmission comprising the one or more engine parameters.

22. The computer-readable media of claim 21, wherein said instructions for receiving comprise instructions for receiving a transmission comprising the one or more engine parameters in one or more macro messages.

23. The computer-readable media of claim 19, wherein said instructions for obtaining comprise instructions for accessing a database to obtain the one or more engine parameters.

24. The computer-readable media of claim 19, wherein said instructions for setting comprise instructions for transmitting the one or more engine parameters on a vehicle data bus.

25. At least one processor configured to perform a method for dynamically setting engine parameters in a vehicle, the method comprising:
detecting one or more operational parameters;
obtaining one or more engine parameters based on the one or more operational parameters;
setting the one or more engine parameters.

26. The method of claim 25, wherein said detecting comprises detecting the one or more operational parameters, wherein the operational parameters comprise one or more of a vehicle position indicator, an engine indicator, a vehicle sensor indicator, and an operator indicator.

27. The method of claim 25, wherein said obtaining comprises:
transmitting the one or more operational parameters; and
receiving a transmission comprising the one or more engine parameters.

28. The method of claim 27, wherein said receiving comprises receiving a transmission comprising the one or more engine parameters in one or more macro messages.

29. The method of claim 25, wherein said obtaining comprises accessing a database to obtain the one or more engine parameters.

30. The method of claim 25, wherein said setting comprising transmitting the one or more engine parameters on a vehicle data bus.
